(19) United States
(12) Patent Application Publication
(10) Pub. No.: US 2004/0145894 A1
(43) Pub. Date: Jul. 29, 2004

(54) Organizing and display device for decorative lighting

(76) Inventor: Danny W. Long, Kankakee, IL (US)

Correspondence Address: Douglas B. White, Suite 102, 1000 East Woodfield Road, Schaumburg, IL, 60173, US

(21) Appl. No.: 10/352,637

(22) Filed: Jan. 28, 2003

(51) Int. Cl. F21V 21/00

(52) U.S. Cl. 362/249; 362/396; 362/147; 362/252

(57) ABSTRACT

An organizing and display device for attachment to (or incorporation into) decorative icicle lighting consists of a series of interconnected rod members, where each rod member has located thereon a plurality of fasteners for attaching the hanging portions of the icicle lighting thereto. The fasteners for attaching the lighting each consist of a releasable interlocking strap member. Attached to one (or more) of the rod members, there is provided an anchor line having a clip for attachment to the structure being decorated.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates generally to decorative lighting of the “icicle” type used during the Christmas holiday season to decorate homes, buildings, and other structures. More particularly, this invention relates to a device used for controlling, displaying, storing, and otherwise organizing these lights and the wires associated therewith.

2. Description of the Prior Art

Icicle lighting is well known and popularly used to provide ornamental lighting on buildings or other appropriate structures. An example of such icicle lighting is described in U.S. Pat. No. 5,975,717. This form of ornamental lighting is quite attractive but presents a problem with the numerous electrical wires which course the edge of the building and dangle therefrom. A decorator would typically attach the horizontal portion of the icicle lighting along a roof line and let the vertical wires and lights thereon freely hang down. Outside lighting of this type is naturally subjected to extreme whether conditions, and strong winds often cause these lights to tangle or flip-up onto the roof, thereby altering their well placed ornamental appearance. And at the end of the season, neat, untangled storage of the icicle lighting is virtually impossible.

Previously, the only disclosed device which offered to provide any degree of control to icicle lighting is an ornamental version described in U.S. Design Pat. No. 386,445, entitled “STRAIGHT WIRE FRAME ICICLE DISPLAY”. However, this device would only provide limited assistance in the organization, control, and storage of the icicle lighting: The wire frame does not easily attach to or detach from the lighting, there is no anchor to keep the lighting neatly in place, and due to its limited flexibility, it is difficult to store during the off-season.

### SUMMARY OF THE INVENTION

Accordingly, it is the principal object of the present invention to provide the long needed display, control and organization for icicle lighting. This is accomplished by a light organizing and display device consisting essentially of a plurality of interconnected stiff members (such as rods) arranged in a series. Each rod member has located thereon a plurality of fasteners for attaching the vertically hanging portions of the icicle lighting to the rod members. Connected to the lower extremities of selected rod members, there are provided anchor lines having clips thereon for attachment to the structure being decorated. In a further feature, the fasteners provided on the rod members are releasable and consist of interlocking straps attached to the rod member. These straps have a protrusion on one end and an opening on the other end for interlocking receipt of the protrusion.

### BRIEF DESCRIPTION OF THE DRAWINGS

FIG. 1 is a perspective view depicting icicle lighting attached to a house and showing the light organizing and display device of the present invention installed therewith.

FIG. 2 is a plan view of the light organizing and display device of the present invention, shown without the icicle lighting attached.

FIG. 3 is a cross sectional view of one of the rod members of the light organizing and display device of FIG. 2, showing a releasable attachment strap.

FIG. 4 shows the flexible interlocking attachment strap of FIG. 3 in its closed interlocked position.

FIG. 5 is shows the light organizing and display device of FIG. 2 having the icicle lighting positioned thereon and partially attached.

FIG. 5a shows the attachment of the lights to the light organizing and display device in more detail.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

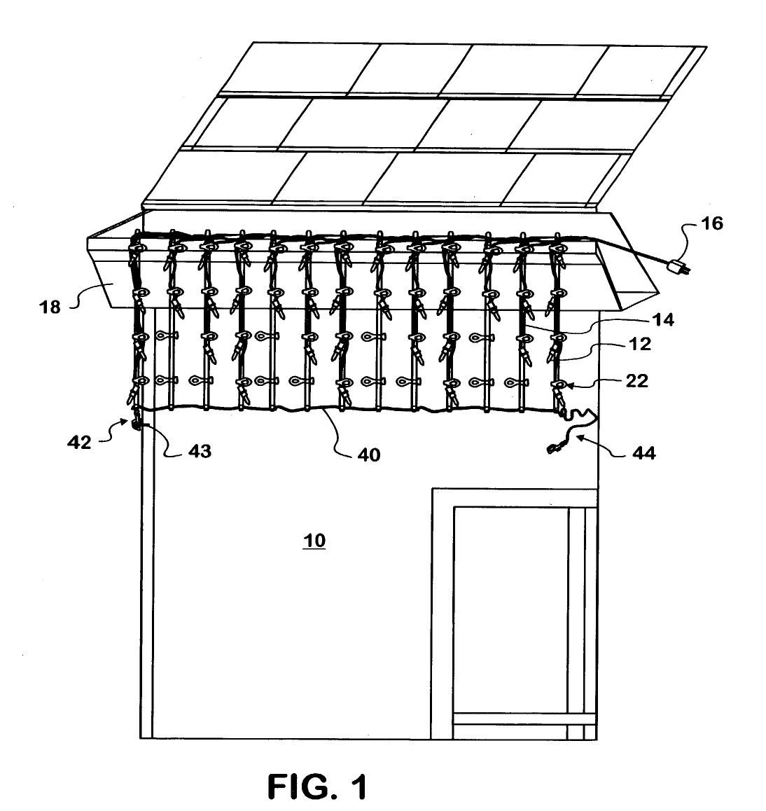

Turning first to FIG. 1 there is shown a structure 10, such as a house, on which decorative lighting in the nature of icicle lights, including the light organizing and display device of the present invention, has been applied along the roof edge. Particularly, this icicle lighting consists of light bulbs 12, numerous segments of vertically hanging clusters of wires 14, and a power cord 16. The horizontal portions of the icicle lighting are shown attached to the gutter 18 of the house, but may be attached to, or along, any other desired feature on the structure. This attachment is accomplished by use of clips or hooks or other means known to the art. When so attached, the icicle lights typically present multiple segments of vertically hanging clusters of wires 14 of varying length, distributed in series along the length of the decorative lighting, as shown in FIG. 1.

The light organizing and display device of the present invention (see FIG. 2) consists of a plurality of spaced elongated organizing members 20, arranged in series, for holding the respective vertical segments of the clusters of strings of wires 14 of the icicle lights. In the preferred embodiment, these organizing members are stiff in nature, such as rods, and have attachment means 22 thereon for fastening and holding the segments of wires 14 of the icicle lights to these organizing members.

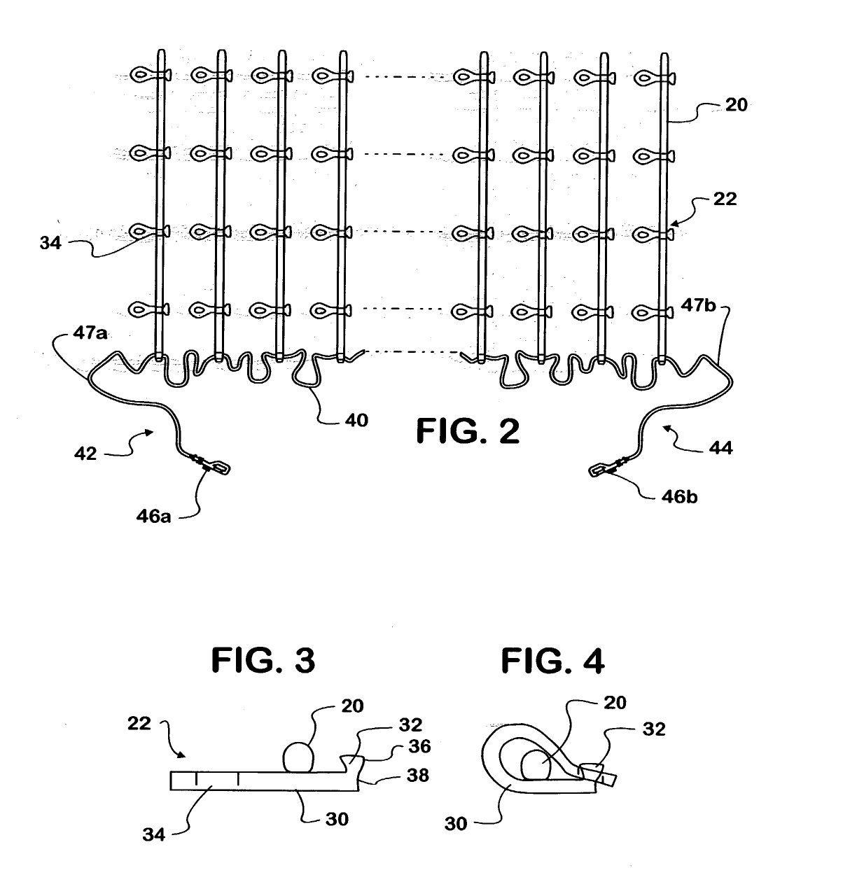

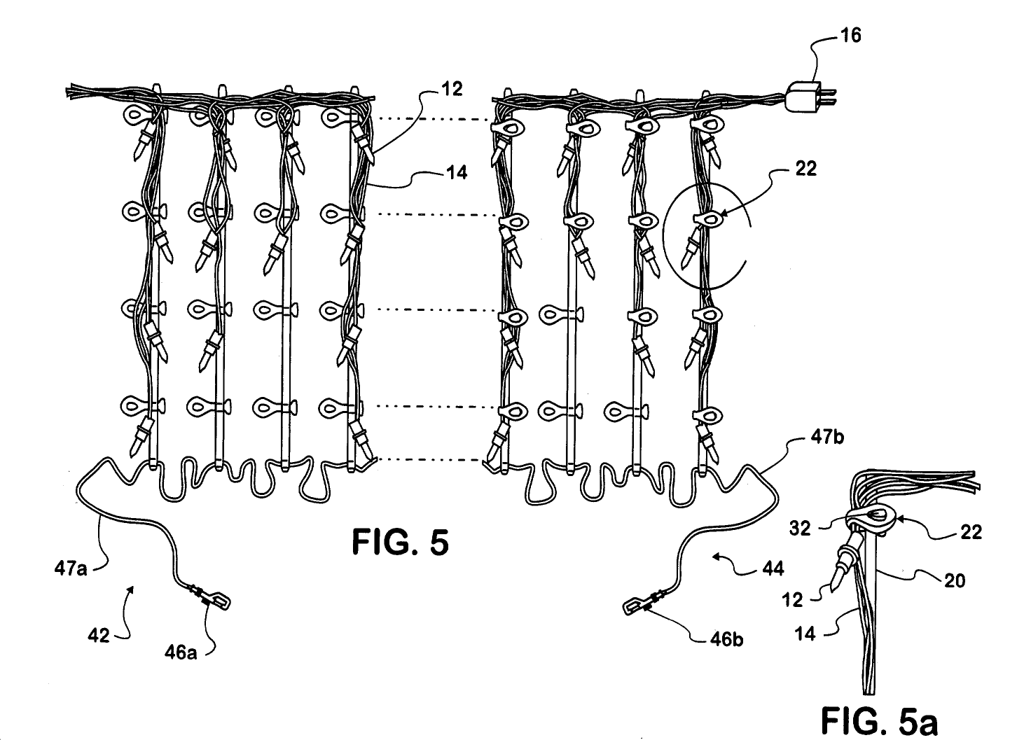

The attachment means 22 preferably comprises flexible releasable interlocking strap members 30 (see FIG. 3). These strap members 30 are affixed to the organizing members 20 and wrap around the segments of wire strings 14 to secure them to the organizing members, as depicted most clearly in FIG. 5a. In order to interlock the extremities of these strap members, they are each arranged with a protrusion 32 on one extremity thereof and an opening 34 on the opposite extremity for receipt of the protrusion 32, as shown most clearly in FIG. 4. Additionally, this protrusion presents a wide outer extremity 36 and narrows at its point of attachment 38 to the strap, and the opening 34 is elastic in nature and is smaller in its un-stretched size than the wide outer extremity 36 of the protrusion 32. Consequently, when the protrusion is forced through the opening 34, the opening first stretches and then retracts to securely hold the protrusion 32 in place.

In a further feature of the preferred embodiment, the spaced organizing members 20 are interconnected by a flexible line 40. This line helps maintain the desired positioning of the lighting, assists in anchoring the lighting, and facilitates the storage of the icicle lights during non-use, as more fully described below. This line 40 is shown attached to the lower extremity of the organizer members 20, but it may be attached at any other available location on the organizing members that will accomplish a similar result. Moreover, this line 40 may equivalently consist of multiple line segments connected between the individual organizing members. When so interconnected, the organizing members 20 with attached lighting easily withstand the wind and elements and will more effectively remain in place as positioned on the structure by the decorator. At the end of the season, the short flexible segments of the line 40 located between each of the organizer members now allows the device to be rolled, folded or gathered (accordion style) for quick, easy, and untangled storage.

In yet a further feature of the preferred embodiment there is provided anchor means 42 and 44 extending from the lower extremities of certain organizing members 20 for securing them to the structure. In the preferred embodiment, this anchor means is affixed to selected organizer members and preferably to each of those positioned at the outer extremity of the series thereof, as shown in FIG. 2, to thereby anchor the vertically hanging portions of the organizing and display device (and the attached lighting) to the structure. This anchor means works in cooperation with the interconnection line 40 to maintain the organizer members in position. FIG. 1 shows the anchor 42 (left side of the drawing) attached 43 to the house structure, and the anchor 44 on the right side of the drawing is unattached.

This anchor means 42 and 44 comprises, in the preferred embodiment, clip means 46a and 46b affixed to the free extremity of flexible anchor lines 47a and 47b for quick and easy attachment to any chosen point on the structure. Such clip means, for facilitating the attachment of the anchor lines, may include a hook or clip member or any other equivalent attachment device known to the art for affixing the anchor line to an anchor point on the structure or elsewhere.

When used with pre-existing icicle lighting, the organizing and display device of the present invention is preferably attached to the icicle lighting using the releasable fastener means described above. This attachment may be accomplished before the lighting is put in place on the structure or afterwards, and is therefore easy to apply to pre-installed lighting. Moreover, the organizing and display device of the present invention may be included as part of the manufactured icicle lighting product itself, with the organizing and display device incorporated into or made integral with the lighting system. With either embodiment, upon removal of the lighting from the structure at the end of the season, the icicle lighting is designed to be left attached to the organizing and display device to assist in its storage, as described above.

From the foregoing description, it will be apparent that modifications can be made to the apparatus and method for using same without departing from the teachings of the present invention. Accordingly, the scope of the invention is only to be limited as necessitated by the accompanying claims.

What is claimed is:

1. An organizing and display device for decorative lighting having segments of wires for the lighting defined thereon, the organizing and display device comprising:
a plurality of spaced organizer members for attachment to respective segments of wires; and
attachment means affixed to said spaced organizer members for fastening respective segments of wires to said spaced organizer members.

2. The organizing and display device of claim 1 wherein said spaced organizer members comprise interconnected stiff members.

3. The organizing and display device of claim 2 wherein said spaced organizer members comprise rods.

4. The organizing and display device of claim 1 wherein said attachment means comprises a plurality of attachment members affixed to each of said respective spaced organizer members.

5. The organizing and display device of claim 4 wherein said attachment members comprise flexible releasable interlocking members.

6. The organizing and display device of claim 5 wherein said flexible interlocking member comprises a strap member having a protrusion located on one extremity thereof and an opening located on the opposite extremity thereof for interlocking receipt of said protrusion.

7. The organizing and display device of claim 2 wherein said attachment means comprises a plurality of attachment members affixed to respective spaced organizer members.

8. The organizing and display device of claim 7 wherein said attachment members comprises a strap member having a protrusion located on one extremity thereof and an opening located on the opposite extremity thereof for releasable interlocking receipt of said protrusion.

9. The organizing and display device of claim 2 further comprising anchor means for attaching the organizing and display device to the structure.

10. The organizing and display device of claim 9 wherein said anchor means comprises one or more flexible lines attached to said organizer members and having clip means attached to the free extremity of said flexible lines for facilitating the attachment thereof.

11. Decorative lighting for mounting on a structure, wherein the decorative lighting has segments of wires defined thereon, the improvement comprising:
a plurality of interconnected spaced organizer members attached to said respective segments of wires; and
attachment means for fastening said respective segments of wires to said spaced organizer members.

12. The decorative lighting of claim 11 further comprising anchor means for attaching said spaced organizing members to the structure.

13. The decorative lighting of claim 12 wherein said anchor means comprises one or more flexible lines having clip means positioned on the free extremities thereof for attachment to the structure.

14. The decorative lighting of claim 11 wherein said spaced organizer members comprise stiff members and said attachment means comprises a plurality of attachment members affixed to said respective spaced organizer members.

15. The decorative lighting of claim 14 further comprising anchor means for attaching the decorative lighting to the structure.

16. The decorative lighting of claim 15 wherein said anchor means comprises one or more flexible lines having clip means positioned on the free extremities thereof for attachment to the structure.

17. The decorative lighting of claim 16 wherein said stiff spaced organizer members comprise rods.

18. The decorative lighting of claim 17 wherein said attachment means comprises flexible interlocking members.

19. The decorative lighting of claim 11 wherein said interconnection of said spaced organizer members comprises a flexible line member affixed to each of said organizer members.

20. The decorative lighting of claim 19 further comprising anchor means affixed to selected organizer members for attaching the decorative lighting to the structure.
